(19) United States
(12) Patent Application Publication
(10) Pub. No.: US 2025/0051093 A1
(43) Pub. Date: Feb. 13, 2025

(54) SECONDARY BATTERY REEL STORAGE RACK AND STACKER CRANE CORRESPONDING TO RACK SHAPE

(71) Applicant: SK On Co., Ltd., Seoul (KR)

(72) Inventors: Jae Hoon JEONG, Daejeon (KR); Yeon Ho PARK, Daejeon (KR); Ju Yeon KIM, Daejeon (KR)

(21) Appl. No.: 18/788,147

(22) Filed: Jul. 30, 2024

(30) Foreign Application Priority Data
Aug. 10, 2023 (KR) 10-2023-0104589

(51) Int. Cl. B65G 1/04

(52) U.S. Cl. CPC B65G 1/0407; B65G 2201/02

(57) ABSTRACT

Provided is a secondary battery reel storage rack to which a secondary battery reel is loaded for storage, the secondary battery reel storage rack including: a loading column perpendicular to the ground; a cantilever protruding parallel to the ground from one side surface of the loading column to support the loaded secondary battery reel; and a cover provided below the cantilever.

### CROSS-REFERENCE TO RELATED APPLICATIONS

This application claims priority under 35 U.S.C. § 119 to Korean Patent Application No. 10-2023-0104589, filed on August 10,2023 in the Korean Intellectual Property Office, the disclosure of which is incorporated herein by reference in its entirety.

### TECHNICAL FIELD

The following disclosure relates to a rack for storing reels for producing secondary batteries.

### BACKGROUND

As one process for producing secondary batteries, a roll-type sheet is cut to have a required width using a slitter after a sheet pressing process. The cut sheet is classified into a long-width semi-finished product or a short-width semi-finished product depending on the width of the cut sheet. Here, the short-width semi-finished product is wound around a reel. The reel, around which the short-width semi-finished product is wound, is loaded onto a shaft-type reel tray. The reel tray is stored in or transported to a reel warehouse for a subsequent process.

The reel tray, on which the reel is loaded, needs to be provided at least in a number in which one reel tray corresponds to one reel. In addition, reel trays are required in a number greater than necessary to correspond to the daily volume in which reels are transported and the number of days for which reels are stored for producing secondary batteries.

As such, the cost incurred by reel trays is so significant that it accounts for at least half of the cost of operating a reel storage warehouse.

The present disclosure can be broadly applied in the field of green technology, such as electric vehicles, battery charging stations, solar power generation using batteries. The present disclosure can be used in the manufacturing of batteries used for eco-friendly electric vehicles, hybrid vehicles, etc., thus contributing to the reduction of air pollution and greenhouse gas emissions.

### PRIOR ART DOCUMENT

[Patent Document]

Korean Patent Laid-Open Publication No. 10-2023-0020675 (Feb. 13, 2023)

### SUMMARY

An embodiment of the present disclosure is directed to providing a secondary battery reel storage rack capable of reducing the cost of auxiliary equipment and storing a large number of reels per area in a reel storage warehouse for producing secondary batteries by not using trays in the warehouse.

In one general aspect, a secondary battery reel storage rack to which a secondary battery reel is loaded for storage includes: a loading column perpendicular to the ground; a cantilever protruding parallel to the ground from one side surface of the loading column to support the loaded secondary battery reel; and a cover provided below the cantilever.

In the secondary battery reel storage rack according to an embodiment, a plurality of cantilevers may be provided at set intervals.

In the secondary battery reel storage rack according to an embodiment, covers may be provided to correspond to the plurality of cantilevers.

In the secondary battery reel storage rack according to an embodiment, the cantilever may have a cross-sectional shape in which both ends thereof are bent downward with respect to a center line of a width of the cantilever, such that a bending line formed in a longitudinal direction supports a core of the secondary battery reel.

In the secondary battery reel storage rack according to another embodiment, the cantilever may have a cross-sectional shape in which both ends thereof may be bent upward with respect to a center line of a width of the cantilever, such that both ends of the cantilever supports a core of the secondary battery reel.

In the secondary battery reel storage rack according to still another embodiment, the cantilever may have a cross-sectional shape in which both ends thereof are bent downward, such that a pair of bending lines formed in a longitudinal direction supports a core of the secondary battery reel.

In another general aspect, a secondary battery reel storage warehouse includes the above-described secondary battery reel storage rack in a plural number.

In another general aspect, a stacker crane for loading or unloading a secondary battery reel to or from the above-described secondary battery reel storage rack includes: a fork portion to be inserted into the core of the secondary battery reel, the fork portion having a bent cross-sectional shape to correspond to the cross-sectional shape of the cantilever.

In the stacker crane according to an embodiment, the fork portion may have a cross-sectional shape in which both ends of a width thereof are bent upward, while the fork portion has a longer width than the cantilever, such that both ends of the fork portion support the core of the secondary battery reel.

In the stacker crane according to another embodiment, the fork portion may have a cross-sectional shape in which both ends thereof are bent upward, while the fork portion has a longer width than the cantilever, such that both ends of the fork portion support the core of the secondary battery reel.

The secondary battery reel storage rack according to the present disclosure is capable of effectively storing a secondary battery reel by supporting a load of the secondary battery reel with only the cantilever when the secondary battery reel is loaded on the cantilever.

The secondary battery reel storage warehouse including the secondary battery reel storage rack according to the present disclosure is capable of storing a large number of secondary battery reels at low cost.

The stacker crane for loading or unloading a secondary battery reel according to the present disclosure is capable of effectively loading or unloading the secondary battery reel to or from the secondary battery reel storage rack, without interfering with the cantilever of the secondary battery reel storage rack.

### BRIEF DESCRIPTION OF THE DRAWINGS

FIG. 1 is a perspective view schematically illustrating a secondary battery reel storage rack according to the present disclosure.

FIG. 2 is a cross-sectional view illustrating a cross-sectional shape of a cantilever of FIG. 1 according to a first embodiment.

FIG. 3 is a cross-sectional view illustrating a cross-sectional shape of a cantilever of FIG. 1 according to a second embodiment.

FIG. 4 is a cross-sectional view illustrating a cross-sectional shape of a cantilever of FIG. 1 according to a third embodiment.

FIG. 5 is a perspective view schematically illustrating a secondary battery reel storage warehouse according to the present disclosure.

FIGS. 6 to 8 are cross-sectional views each illustrating a cross-section of a fork portion in a stacker crane for loading or unloading a secondary battery reel according to a first embodiment of the present disclosure.

FIG. 9 is a cross-sectional view illustrating a cross-section of a fork portion in a stacker crane for loading or unloading a secondary battery reel according to a second embodiment of the present disclosure.

### DETAILED DESCRIPTION OF MAIN ELEMENTS

10: Secondary battery reel
11: Core of secondary battery reel
100: Secondary battery reel storage rack
110: Loading column
120: Cantilever
121: Bending line
122: Both ends of cantilever
123: Pair of bending lines
130: Cover
200: Secondary battery reel storage warehouse
300: Stacker crane
310: Fork portion
311: Both ends of fork portion

### Detailed Description of Embodiments

Hereinafter, the present disclosure will be described in detail with reference to the accompanying drawings. However, the specific embodiments disclosed herein are merely exemplary, and the present disclosure is not limited thereto.

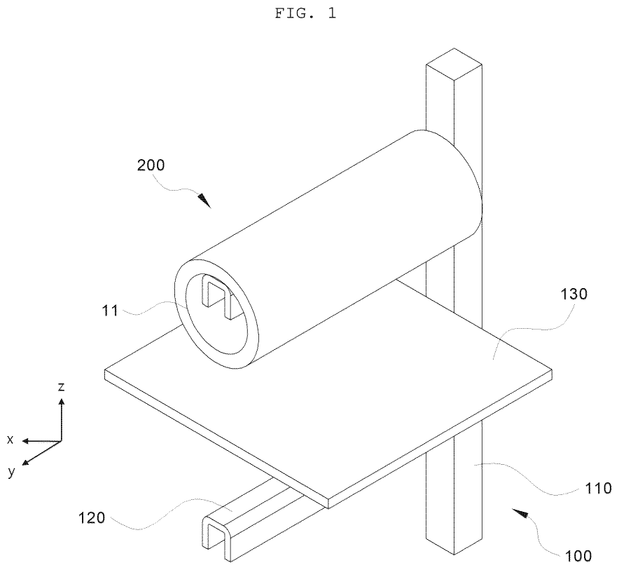

A secondary battery reel storage rack 100 according to the present disclosure is provided to store reels around which short-width semi-finished products are wound in a secondary battery producing process. Referring to FIG. 1, the secondary battery reel storage rack 100 according to the present disclosure includes a loading column 110, a cantilever 120, and a cover 130.

The loading column 110 may be erected perpendicular (a z-axis direction in FIG. 1, hereinafter the same applies) to the ground (an x-y plane in FIG. 1, hereinafter the same applies) in the form of a rod or bar.

The cantilever 120 is provided on the loading column 110 parallel (a direction parallel to the x-y plane in FIG. 1, hereinafter the same applies) to the ground in the form of a beam. The cantilever 120 is provided to support a secondary battery reel 10 loaded on the secondary battery reel storage rack 100.

The cantilever 120 may be disposed on one side surface of the loading column 110. The cantilever 120 is formed to protrude from one side surface in a direction parallel to the ground. Based on FIG. 1, the cantilever 120 may be formed to protrude parallel to the ground (here, protrude in a y-axis direction) from one side surface of the loading column 110 erected perpendicular to the ground.

A plurality of cantilevers 120 may be provided at set intervals.

The cantilevers 120 may be arranged at regular intervals in the vertical direction on the same side surface of the loading column 110. The provision of the plurality of cantilevers 120 on one loading column 110 is to efficiently store secondary battery reels 10.

Based on FIG. 1, two cantilevers 120 are arranged at a set interval on the loading column 110. The number of cantilevers 120 is not limited to FIG. 1, and may vary depending on a height of the loading column 110 and a situation of a secondary battery storage warehouse where the secondary battery reel storage rack 100 is installed.

The set interval between the plurality of cantilevers 120 may vary depending on a diameter of the secondary battery reel 10. The interval between the plurality of cantilevers 120 may be preferably set to be larger than the diameter of the secondary battery reel 10 so that the loaded secondary battery reels 10 do not interfere with each other.

The cover 130 may be provided below the cantilever 120. The cover 130 is provided between the two cantilevers 120. The cover 130 is provided to receive foreign substances that may fall from the secondary battery reel 10 loaded on the upper cantilever 120.

Covers 130 may be provided to correspond to the plurality of cantilevers 110.

The cantilever 120 is in the form of a beam that protrudes to be long in a horizontal direction from the loading column 110. Referring back to FIG. 1, the cantilever 120 supports the secondary battery reel 10 by entering a core 11 of the secondary battery reel. In order to sustain a load of the secondary battery reel 10, the cantilever 120 may have a bent cross-sectional shape.

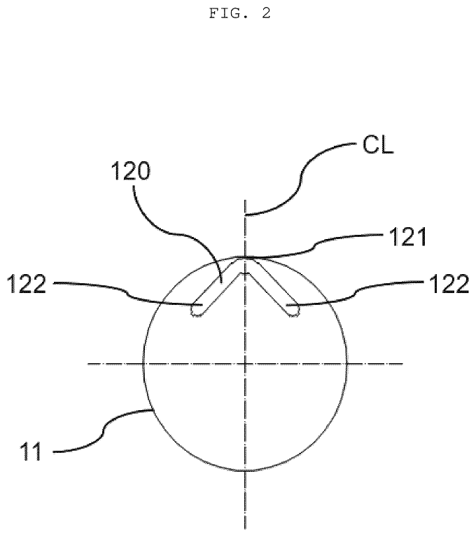

Hereinafter, various embodiments of cantilevers 120 having bent cross-sectional shapes will be described with reference to FIGS. 2 to 4.

Referring to FIG. 2, a cantilever 120 according to a first embodiment may have a cross-sectional shape in which both ends 122 thereof are bent downward with respect to a center line CL of a width of the cantilever 120. The cantilever 120 in FIG. 2 may have a “∧”-shaped cross section.

In this case, the cantilever 120 forms a bending line 121 in a longitudinal direction (the y-axis direction in FIG. 1, hereinafter the same applies). The bending line 121 supports a core 11 of a secondary battery reel.

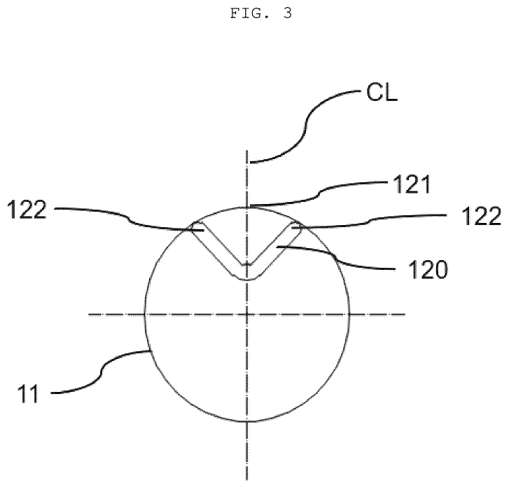

Referring to FIG. 3, a cantilever 120 according to a second embodiment may have a cross-sectional shape in which both ends 122 thereof are bent upward with respect to a center line CL of a width of the cantilever 120. The cantilever 120 in FIG. 3 may have a “∨”-shaped cross section.

In this case, both ends 122 of the cantilever 120 support a core 11 of a secondary battery reel.

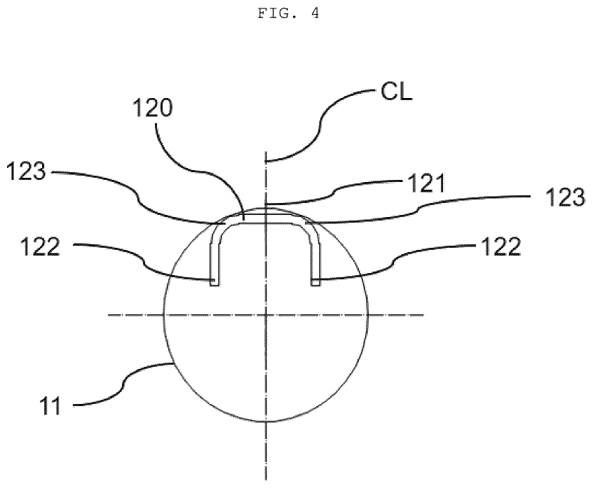

Referring to FIG. 4, a cantilever 120 according to a third embodiment may have a cross-sectional shape in which both ends 122 thereof are bent downward. The cantilever 120 in FIG. 3 may have a “∩”-shaped cross section.

In this case, the cantilever 120 forms a pair of bending lines 123 formed in a longitudinal direction. (Here, the longitudinal direction is a direction based on a length that is a distance from one end to the other end of the cantilever 120, and refers to the y-axis direction based on FIG. 1.) The pair of bending lines 123 supports a core 11 of a secondary battery reel.

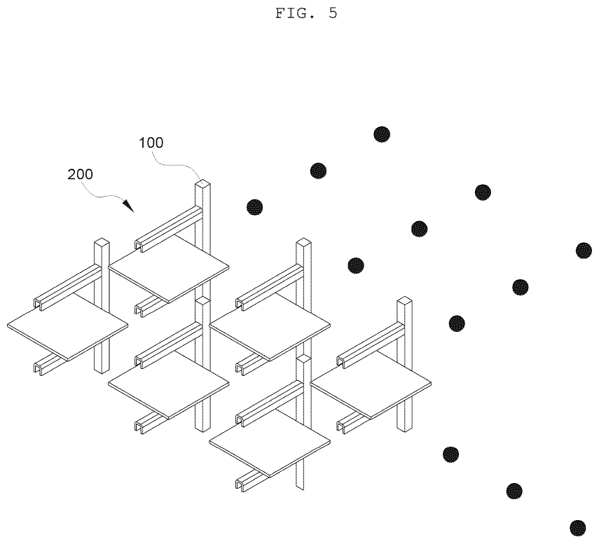

Referring to FIG. 5, a plurality of secondary battery reel storage racks 100, each having been described above, may be provided to form a secondary battery reel storage warehouse 200. In the secondary battery reel storage warehouse 200, the plurality of secondary battery reel storage racks 100 may be arranged in rows and columns at set intervals.

Hereinafter, a fork portion 310 formed to enter the core 11 of the secondary battery reel in a stacker crane 300 that loads or unloads the secondary battery reel 10 to or from the secondary battery reel storage rack 100 described above will be described.

The stacker crane 300 is a crane used to load or unload reel-type loads, and detailed description and illustration thereof will be omitted because it is a publicly known technology. Hereinafter, the fork portion 310 of the stacker crane 300, which is a feature, will be described in detail.

The stacker crane 300 includes a fork portion 310 to be inserted into the core 11 of the secondary battery reel. The fork portion 310 may have a bent cross-sectional shape to correspond to the cross-sectional shape of the cantilever 120.

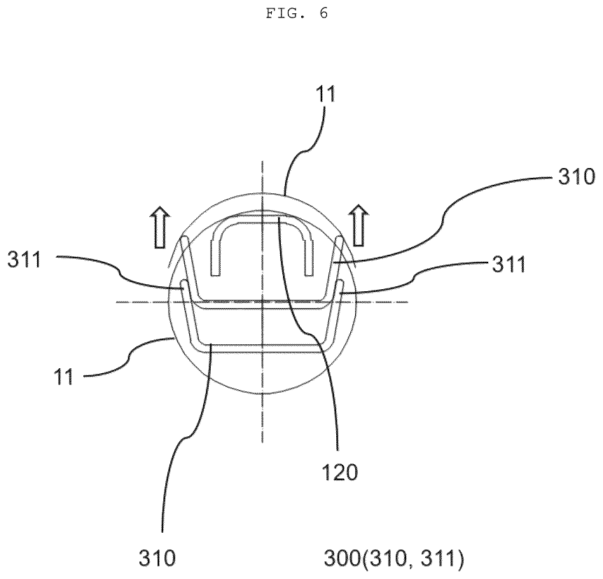

Referring to FIGS. 6 to 8, a fork portion 310 according to the first embodiment may have a cross-sectional shape in which both ends 311 thereof are bent upward. Here, the fork portion 310 may have a “∪”-shaped cross section.

In this case, both ends 311 of the fork portion 310 support a core 11 of a secondary battery reel. The fork portion 310 is formed to have a longer width than the cantilever 120. Both ends 311 of the fork portion may support the core 11 of the secondary battery reel. This prevents the fork portion 310 from interfering with the cantilever 120 when it enters the core 11 of the secondary battery reel.

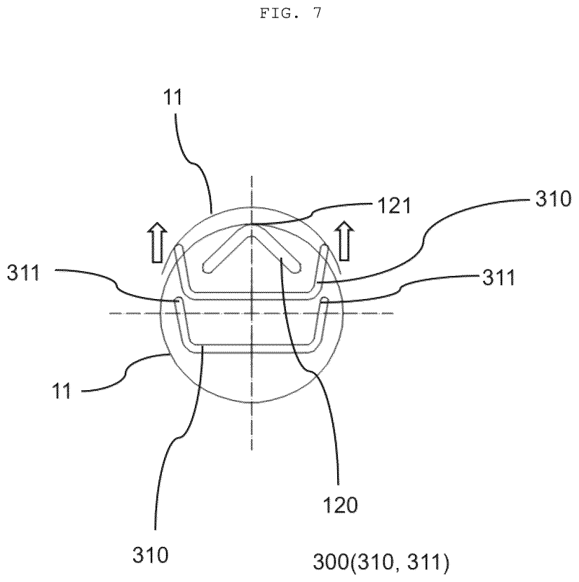

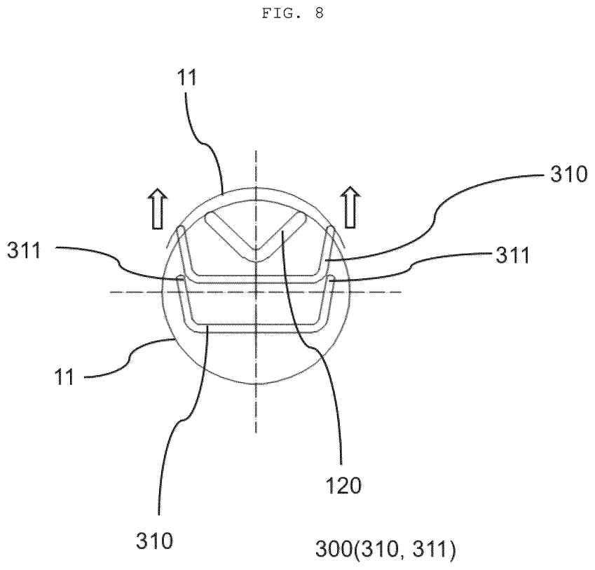

FIG. 6 illustrates a case where the cantilever 120 has a “∩”-shaped cross section. FIG. 7 illustrates a case where the cantilever 120 has a “∧”-shaped cross section, and FIG. 8 illustrates a case where the cantilever 120 has a “∨”-shaped cross section.

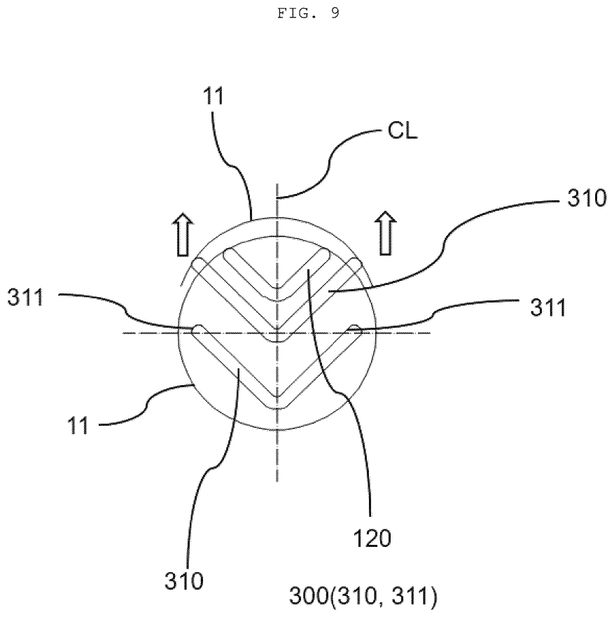

Referring to FIG. 9, a fork portion 310 according to a second embodiment may have a cross-sectional shape in which both ends 311 are bent upward. Here, the fork portion 310 may have a “∨”-shaped cross section.

The fork portion 310 has a longer width than the cantilever 120, such that both ends 311 of the fork portion support a core 11 of a secondary battery reel.

The fork portion 310 having the cross-sectional shape described above makes it possible to raise the secondary battery reel upward while supporting the core 11 of the secondary battery reel without interfering with the cantilever 120.

The above description is merely an example to which the principle of the present disclosure is applied, and other configurations may be further included without departing from the scope of the present disclosure.

What is claimed is:

1. A secondary battery reel storage rack to which a secondary battery reel is loaded for storage, the secondary battery reel storage rack comprising:
a loading column perpendicular to the ground;
a cantilever protruding parallel to the ground from one side surface of the loading column to support the loaded secondary battery reel; and
a cover provided below the cantilever.

2. The secondary battery reel storage rack of claim 1, wherein a plurality of cantilevers are provided at set intervals.

3. The secondary battery reel storage rack of claim 2, wherein covers are provided to correspond to the plurality of cantilevers.

4. The secondary battery reel storage rack of claim 1, wherein the cantilever has a cross-sectional shape in which both ends thereof are bent downward with respect to a center line of a width of the cantilever, such that a bending line formed in a longitudinal direction supports a core of the secondary battery reel.

5. The secondary battery reel storage rack of claim 1, wherein the cantilever has a cross-sectional shape in which both ends thereof are bent upward with respect to a center line of a width of the cantilever, such that both ends of the cantilever supports a core of the secondary battery reel.

6. The secondary battery reel storage rack of claim 1, wherein the cantilever has a cross-sectional shape in which both ends thereof are bent downward, such that a pair of bending lines formed in a longitudinal direction supports a core of the secondary battery reel.

7. A secondary battery reel storage warehouse comprising the secondary battery reel storage rack of claim 1 in a plural number.

8. A stacker crane for loading or unloading a secondary battery reel to or from the secondary battery reel storage rack of any of claim 1, the stacker crane comprising:
a fork portion to be inserted into the core of the secondary battery reel, the fork portion having a bent cross-sectional shape to correspond to the cross-sectional shape of the cantilever.

9. The stacker crane of claim 8, wherein the cantilever has a cross-sectional shape in which both ends thereof are bent downward with respect to a center line of a width of the cantilever, such that a bending line formed in a longitudinal direction supports a core of the secondary battery reel.

10. The stacker crane of claim 8, wherein the cantilever has a cross-sectional shape in which both ends thereof are bent upward with respect to a center line of a width of the cantilever, such that both ends of the cantilever supports a core of the secondary battery reel.

11. The stacker crane of claim 8, wherein the cantilever has a cross-sectional shape in which both ends thereof are bent downward, such that a pair of bending lines formed in a longitudinal direction supports a core of the secondary battery reel.

12. The stacker crane of claim 9, wherein the fork portion has a cross-sectional shape in which both ends of a width thereof are bent upward, while the fork portion has a longer width than the cantilever, such that both ends of the fork portion support the core of the secondary battery reel.

13. The stacker crane of claim 9, wherein the fork portion has a cross-sectional shape in which both ends thereof are bent upward, while the fork portion has a longer width than the cantilever, such that both ends of the fork portion support the core of the secondary battery reel.

14. The stacker crane of claim 10, wherein the fork portion has a cross-sectional shape in which both ends of a width thereof are bent upward, while the fork portion has a longer width than the cantilever, such that both ends of the fork portion support the core of the secondary battery reel.

15. The stacker crane of claim 10, wherein the fork portion has a cross-sectional shape in which both ends thereof are bent upward, while the fork portion has a longer width than the cantilever, such that both ends of the fork portion support the core of the secondary battery reel.

16. The stacker crane of claim 11, wherein the fork portion has a cross-sectional shape in which both ends of a width thereof are bent upward, while the fork portion has a longer width than the cantilever, such that both ends of the fork portion support the core of the secondary battery reel.

17. The stacker crane of claim 11, wherein the fork portion has a cross-sectional shape in which both ends thereof are bent upward, while the fork portion has a longer width than the cantilever, such that both ends of the fork portion support the core of the secondary battery reel.
